(19) United States
(12) Patent Application Publication
(10) Pub. No.: US 2014/0365751 A1
(43) Pub. Date: Dec. 11, 2014

(54) OPERAND GENERATION IN AT LEAST ONE PROCESSING PIPELINE

(71) Applicant: ARM LIMITED, Cambridge (GB)

(72) Inventors: Ian Michael CAULFIELD, Cambridge (GB); Max BATLEY, Cambridge (GB); Peter Richard GREENHALGH, Cambridge (GB)

(73) Assignee: ARM LIMITED, Cambridge (GB)

(21) Appl. No.: 14/273,723

(22) Filed: May 9, 2014

(30) Foreign Application Priority Data
Jun. 10, 2013 (GB) 1310271.0

(51) Int. Cl. G06F 9/38; G06F 9/30

(52) U.S. Cl. CPC G06F 9/3867; G06F 9/30029
USPC 712/224; 712/220

(57) ABSTRACT

A data processing apparatus has at least one processing pipeline having first, second and third pipeline stages. The first pipeline stage detects whether a stream of instructions to be processed includes a predetermined instruction sequence comprising first and second instructions for performing first and second operand generation operations, where the second operand generation operation is dependent on an outcome of the first. In response to detecting this instruction sequence, the first pipeline stage generates a modified stream of instructions in which at least the second instruction is replaced with a third instruction for performing a combined operand generation operation having the same effect as the first and second operand generation operations. As the third instruction can be scheduled independently of the first instruction, processing performance of the pipeline can be improved.

### TECHNICAL FIELD

The present invention relates to the field of data processing. More particularly, the invention relates to the generation of operands in at least one processing pipeline of a processor.

### TECHNICAL BACKGROUND

A processor may have a processing pipeline which has several pipeline stages for processing instructions. An instruction for performing a certain operation may require a particular pipeline stage to perform that operation. If a required operand is not available in time for the pipeline stage that uses the operand, then the instruction may need to be delayed and issued in a later processing cycle, which reduces processing performance. The present technique seeks to address this problem and improve throughput of instructions through the processing pipeline.

### SUMMARY OF THE INVENTION

Viewed from one aspect the present invention provides a processor comprising:

at least one processing pipeline configured to process a stream of instructions, the at least one processing pipeline comprising a first pipeline stage, a second pipeline stage and a third pipeline stage; wherein:

the first pipeline stage is configured to detect whether the stream of instructions comprises a predetermined instruction sequence comprising a first instruction for performing a first operand generation operation at the third pipeline stage and a second instruction for performing a second operand generation operation at the second pipeline stage, where the second operand generation operation is dependent on an outcome of the first operand generation operation; and

in response to detecting that the stream of instructions comprises said predetermined instruction sequence, the first pipeline stage is configured to generate a modified stream of instructions for processing by the at least one processing pipeline in which at least the second instruction is replaced with a third instruction for performing a combined operand generation operation for generating an operand equivalent to the operand which would be generated if the second operand generation operation was performed after the first operand generation operation.

A processing pipeline may process a predetermined sequence of instructions in which a first instruction performs a first operand generation operation and a second instruction performs a second operand generation operation which is dependent on an outcome of the first operand generation operation. This dependency limits the timings at which these instructions can be processed since the second instruction must wait for the outcome of the first instruction before it can proceed with the second operand generation operation. The second instruction may have to be delayed for one or more cycles, slowing the overall processing of these instructions.

To address this issue, a first pipeline stage of the pipeline detects whether a stream of instructions to be processed includes the predetermined instruction sequence. If the predetermined instruction sequence is detected, then a modified stream of instructions is generated for processing by the pipeline, in which at least the second instruction is replaced with a third instruction for performing a combined operand generation operation. The combined operand generation operation has the same effect as would occur if the second operand generation operation was performed after the first operand generation operation. Since the combination of the two operand generation operations can now be performed using one instruction, this eliminates the dependency problem and frees the pipeline to schedule the third instruction independently of the first instruction. In many cases, this allows the third instruction to be processed at least one cycle earlier than if the first and second instructions were processed by the pipeline in their original form.

This technique is particularly useful if the first, second and third pipeline stages are such that an instruction at the first pipeline stage requires a certain number of processing cycles to reach the second pipeline stage and at least that number of cycles to reach the third pipeline stage. Since the third pipeline stage for performing the first operand generation operation is at the same stage or further down the pipeline than the second pipeline stage for performing the second operand generation operation, this makes it difficult for the first and second instructions to be scheduled in back-to-back processing cycles because it is unlikely that the result of the first operand generation operation in the third pipeline stage could be forwarded back to the second pipeline stage in time for the second operand generation operation. Therefore, it is likely that processing the first and second instructions in their original form will cause a bubble in the pipeline (a processing cycle when no instruction is being processed by a pipeline stage), and so breaking the dependency by replacing at least the second instruction with a modified third instruction for performing the combined operand generation operation is useful for avoiding the bubble and speeding up processing.

The operand generated by the combined operand generation operation or generated by the first and second operand generation operations may be any value used by an instruction processed by the pipeline. For example, the operand may be an address.

In one example, the first operand generation operation may be for generating a first portion of the operand and the second operand generation operation may be for generating a full operand including both the first portion and a second portion. The combined operand generation operation may also generate the full operand including both the first and second portions. This two-stage generation of an operand is particularly useful when the operand to be generated is larger than the number of bits available for representing an operand in the encoding of a single instruction. The third instruction can generate the larger operand in one instruction because it is an internally generated instruction which is generated by the first pipeline stage, rather than an instruction stored in memory that has been encoded by a programmer or a compiler, and so the third instruction need not follow the normal encoding rules for the instruction set being used. The third instruction can be represented in the modified stream of instructions using any information necessary for controlling the at least one pipeline to carry out the combined operand generation operation.

The first operand generation operation may comprise generating the first portion of the operand by adding an offset value to at least a portion of a base value stored in a storage location such as a register. For example, the base value may be a program counter indicating an address of an instruction to be processed (e.g. the currently processed instruction or the next instruction to be processed), in which case the first operand generation operation would generate an address which has been offset relative to the program counter.

The first pipeline stage need not detect all occurrences of the first and second instructions as representing the predetermined instruction sequence for which the second instruction should be replaced with the third instruction. Sometimes, it may be desired not to replace the second instruction with the third instruction even if there are first and second instructions as mentioned above. For example, where the operand is generated based on a portion of the program counter, then the first pipeline stage may detect the predetermined instruction sequence if the first and second instructions have the same value for the portion of the program counter used for the operand generation. Otherwise, the third instruction (which would typically have the same address as the second instruction) could give a different result to the combination of the first and second instructions because the portion of the program counter for the third instruction may be different to that of the first instruction. By performing the replacement of the second instruction with the third instruction only if the first and second instructions share the same value for the relevant portion of the program counter, the correct outcome can be ensured.

The first operation generation operation may add the offset value to a most significant portion of the base value. The offset value may need to be shifted before performing this addition in order to align it with the most significant portion of the base value. In the case of a program counter, the most significant portion may represent a page portion of the address, indicating the page of memory including the instruction being processed. By adding the offset to the page portion of the program counter, the first operand generation operation can determine the address of a different page of the address space, for example a page including a literal value to be accessed. The first operand generation operation may mask a least significant portion of the base value so that the page offset within a page of memory is not determined by this operation. The second operand generation operation may then add an immediate value to the least significant portion of the result of the first operand generation operation, to provide a full memory address of a data value to be accessed. In some architectures, memory addresses may have a greater number of bits than the encoding space in the instruction available for encoding an operand (for example, a 32-bit address may be generated with instructions which only have 21 bits available for encoding an operand). In this case, the two part address generation using the first and second instructions in sequence can be useful, and to improve performance, at least the second instruction can be replaced with a third instruction which generates the full memory address using a single instruction.

The second instruction of the predetermined sequence may perform a further processing operation using the operand generated by the second operand generating operation. Similarly, the third instruction which replaces the second instruction may perform the same processing operation. This processing operation may comprise at least one of a load operation for loading from memory a data value having an address identified by the generated operand, a store operation for storing to memory a data value having an address identified by the generated operand, an arithmetic operation such as an add, subtract or multiply operation which uses the generated operand, and a logical operation such as an AND, OR NAND or XOR operation which uses the generated operand.

Alternatively, the second instruction and its replacement third instruction may simply store the generated operand to a storage location (e.g. a register) where it can be accessed by another instruction. Therefore, it is not essential for the second and third instructions to perform other operations as well as the operand generation. The third instruction which replaces the second instruction in the modified sequence can be processed in either the second pipeline stage or the third pipeline stage as desired in a particular implementation of the pipeline.

As the third instruction has the same effect as the combination of the first and second operand generation operations of the first and second instructions, it is possible to omit the first instruction from the modified stream as well as the second instruction, so that the third instruction replaces both the first and second instructions of the predetermined instruction sequence.

However, the second instruction may not be the only instruction which uses the outcome of the first instruction. For example, the same first instruction may be shared by several subsequent instructions which each use the same partial operand generation. For example, the first instruction may generate an address of a particular page in memory as discussed above, and then several instructions similar to the second instruction may access different addresses within the same page. In this case, the first instruction may still need to be completed even though this is not required for performing the third instruction. Therefore, the modified stream of instruction may comprise both the first instruction and the third instruction, so that only the second instruction is replaced by the third instruction in the modified stream. The pipeline may schedule processing of the third instruction independently of processing of the first instruction. The first and third instructions can be issued in the same cycle or in successive processing cycles, and it does not matter whether the outcome of the first instruction will be ready in time for the third instruction.

Another reason why the modified stream of instructions may still include the first instruction is that in some cases the first instruction may already have been issued for execution at the point when the second instruction is encountered. It may more efficient to let the first instruction complete execution even though its result is not required for the third instruction which replaces the second instruction.

To determine whether the first instruction should be retained within the modified stream, the first pipeline stage may determine whether the stream of instructions comprises a fourth instruction which is dependent on the outcome of the first operand generation operation of the first instruction. If there is a fourth instruction using the outcome of the first instruction, then the first instruction can be retained, while otherwise the first instruction can be omitted.

However, the first pipeline stage may not have access to the entire stream of instructions, or may not be able to determine for sure whether there are subsequent instructions which use the result of the first instruction. It may be simpler to always include the first instruction in the modified stream of instructions irrespective of whether there is a subsequent instruction which will use this outcome. This may be more efficient in terms of hardware.

Alternatively, while the first pipeline stage may not always be able to determine whether there will be a subsequent instruction using the result of the first instruction, there may be certain situations in which it is guaranteed that there cannot be a subsequent instruction using the outcome of the first operand generation operation. For example, an instruction following the second instruction in the stream of instructions could overwrite the register to which the first instruction writes the outcome of the first operand generation operation. In this case, it would be known that there cannot be any further instructions which depend on the outcome of the first operand generation operation, and in this case the first instruction could be replaced with the third instruction. Hence, the first pipeline stage may determine whether a subsequent instruction could be dependent upon the outcome of the first operand generation operation, and if it is known that there can be no subsequent dependent instruction, then the first and second instruction may be replaced with the third instruction, while if a subsequent instruction could be dependent, then only the second instruction is replaced.

The first and second instructions do not need to be adjacent to each other in the original stream of instructions. The first pipeline stage may detect, as the predetermined instruction sequence, a sequence of instructions which includes one or more intervening instructions between the first and second instructions. To reduce the complexity of the hardware in the first pipeline stage for detecting such sequences, it can be useful to define a maximum number N of intervening instructions which may occur between the first and second instructions in order for such a sequence to be detected. In practice, once several intervening instructions have occurred, then the dependency between the first and second instructions becomes less problematic since it is more likely that the first instruction will have completed before the second instruction reaches the second pipeline stage. By reducing the number of consecutive instructions in a sequence which is checked for the presence of the first instruction and second instruction, the hardware overhead of this detection can be reduced.

Some pipeline stages may set the maximum number N to zero so that only predetermined sequences of instructions having the first and second instructions adjacent to each other are detected. Other systems may define a non-zero number of intervening instructions. For example, if N=2 then the first pipeline stage may check each set of four consecutive instructions to detect whether they contain a pair of first and second instructions as discussed above.

The first pipeline stage which performs the detection of the predetermined instruction sequence may be any stage of the pipeline. For example, the first pipeline stage may be a decode stage which decodes instructions and the modified stream of instructions may be a stream of decoded instructions, so that when a second instruction is decoded, it is checked whether it follows a recent first instruction, and if so, the second instruction is replaced with a decoded third instruction. Alternatively, the first pipeline stage may be an issue stage which controls the timing at which instructions are issued for processing by the pipeline. The first pipeline stage could be the same stage as one of the second and third pipeline stages.

The second and third pipeline stages which perform the second and first operand generation operations respectively may be located within the same processing pipeline or within different pipelines. Also the second and third pipeline stages may in fact be the same pipeline stage within a particular pipeline.

While the present technique could be used in an out-of-order processor, it is particularly useful in an in-order processor. An out-of-order processor can ensure forward progress even if data dependency hazards occur, by changing the order in which instructions are issued for execution. However, this is not possible in an in-order processor, in which instructions are issued in their original program order. In an in-order processing pipeline, if the first and second instructions were processed by the pipeline in their original form and issued in consecutive cycles, and the result of the first instruction would not be available in time for use by the second instruction at the second pipeline stage, then the second instruction would have to be delayed for a processing cycle. Due to the in-order nature of the processor, it would not be possible to process another instruction in the meantime. Therefore, there would be a bubble in the pipeline, which reduces processing performance. In contrast, with the present technique, the data dependency is avoided by replacing the second instruction with the third instruction, and so there is no constraint on the cycle in which the third instruction can be issued. Even if the first instruction remains in the modified stream, the third instruction is not dependent on the first instruction and so these instructions can be issued in the same processing cycle or in consecutive cycles.

Viewed from another aspect, the present invention provides a processor comprising:

at least one processing pipeline means for processing a stream of instructions, the at least one processing pipeline means comprising first, second and third pipeline stage means for processing instructions; wherein:

the first pipeline stage means is configured to detect whether the stream of instructions comprises a predetermined instruction sequence comprising a first instruction for performing a first operand generation operation at the third pipeline stage means and a second instruction for performing a second operand generation operation at the second pipeline stage means, where the second operand generation operation is dependent on an outcome of the first operand generation operation; and

in response to detecting that the stream of instructions comprises said predetermined instruction sequence, the first pipeline stage means is configured to generate a modified stream of instructions for processing by the at least one processing pipeline means in which at least the second instruction is replaced with a third instruction for performing a combined operand generation operation for generating an operand equivalent to the operand which would be generated if the second operand generation operation was performed after the first operand generation operation.

Viewed from a further aspect, the present invention provides a data processing method for a processor comprising at least one processing pipeline configured to process a stream of instructions, the at least one processing pipeline comprising a first pipeline stage, a second pipeline stage and a third pipeline stage; the method comprising:

detecting, at the first pipeline stage, whether the stream of instructions comprises a predetermined instruction sequence comprising a first instruction for performing a first operand generation operation at the third pipeline stage and a second instruction for performing a second operand generation operation at the second pipeline stage, where the second operand generation operation is dependent on an outcome of the first operand generation operation; and

in response to detecting that the stream of instructions comprises said predetermined instruction sequence, the first pipeline stage generating a modified stream of instructions for processing by the at least one processing pipeline in which at least the second instruction is replaced with a third instruction for performing a combined operand generation operation for generating an operand equivalent to the operand which would be generated if the second operand generation operation was performed after the first operand generation operation.

Viewed from another aspect, the present invention provides a computer-readable storage medium storing at least one computer program which, when executed on a computer, controls the computer to provide a virtual machine environment corresponding to the processor described above.

Viewed from another aspect, the present invention provides a computer-readable storage medium storing at least one computer program which, when executed on a computer, controls the computer to provide a virtual machine environment for performing the method described above.

These computer-readable storage media may be non-transitory. A virtual machine may be implemented by at least one computer program which, when executed on a computer, controls the computer to behave as if it was a processor having one or more pipelines as discussed above, so that instructions executed on the computer are executed as if they were executed on the processor even if the computer does not have the same hardware and/or architecture as the processor. A virtual machine environment allows a native system to execute non-native code by running a virtual machine corresponding to the non-native system for which the non-native code was designed. Hence, in the virtual machine environment the virtual machine program may replace at least the second instruction with the third instruction as discussed above.

### BRIEF DESCRIPTION OF THE DRAWINGS

The above, and other objects, features and advantages of this invention will be apparent from the following detailed description of illustrative embodiments which is to be read in connection with the accompanying drawings, in which:

FIG. 1 illustrates an example of a processing pipeline;

FIGS. 2A and 2B respectively illustrate an original stream of instructions and a modified stream of instructions;

FIG. 3 illustrates a first address generation operation;

FIG. 4 illustrates a second address generation operation;

FIG. 5 illustrates a combined address generation operation having the same result as the combination of the first and second address generation operations;

FIG. 6 is a timing diagram illustrating the timings at which the instructions of FIG. 2A can be executed;

FIG. 7 is a timing diagram illustrating the timings at which the instructions of FIG. 2B can be executed in a system permitting dual issue of instructions;

FIG. 8 is a timing diagram illustrating the timings at which the instructions of FIG. 2B can be executed in a system which can only issue a single instruction per cycle;

FIG. 9 illustrates a method of processing instructions in the pipeline;

FIG. 10 illustrates an example in which there are two processing pipelines; and

FIG. 11 illustrates a virtual machine implementation of the present technique.

### DESCRIPTION OF EXAMPLE EMBODIMENTS

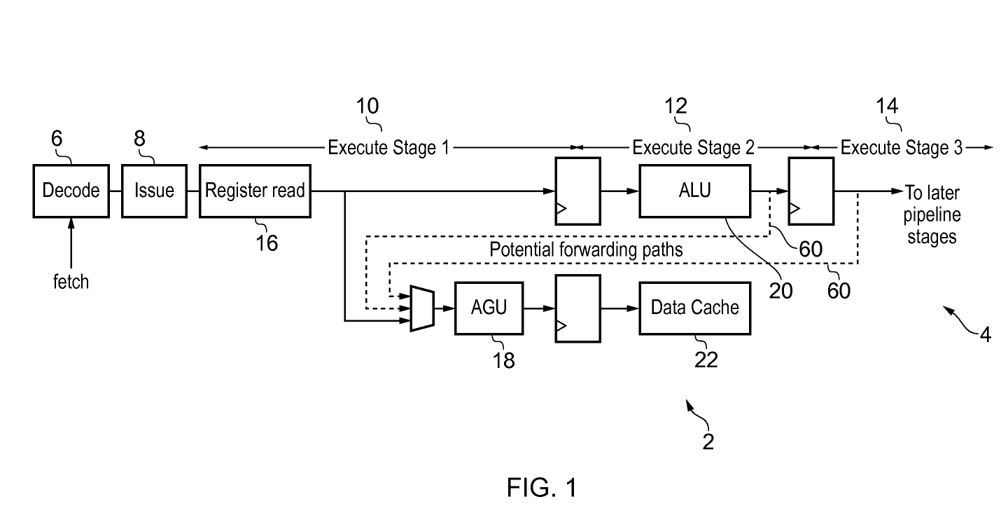

FIG. 1 shows an example of a portion of a data processing apparatus 2 having a processing pipeline 4. The pipeline 4 has a decode stage 6 for decoding instructions fetched from memory, an issue stage 8 for issuing instructions for processing by subsequent stages, and a first execute stage 10, second execute stage 12 and third execute stage 14 for performing various operations in response to executed instructions. In this example, an instruction at the decode stage 6 requires one processing cycle to reach the issue stage 8 and two, three and four processing cycles to reach the first, second and third execute stages 10, 12, 14 respectively. It will be appreciated that the processor 2 and the pipeline 4 may include other stages and elements not shown in FIG. 1.

The first execute stage 10 in this example has register read circuitry 16 for reading operand values from registers and an address generation unit (AGU) 18 for generating addresses. The second execute stage 12 includes an arithmetic logic unit (ALU) 20 for performing arithmetic operations (such as add, subtract, multiply and divide operations) and logical operations (such as bitwise AND, OR or XOR operations). The second execute stage 12 also includes a data cache access circuitry 22 for accessing a cache and for carrying out load/store operations. The AGU 18 is a special address generation unit which is provided to perform several common address generation operations at a relatively early stage of the pipeline 4 so that subsequent stages can use the address. For example, the data cache accessing circuitry 22 in the second execute stage 12 can load or store data values having the address generated by the AGU 18 in the first execute stage 10. Providing the AGU 18 at an early stage of the pipeline helps to reduce memory access latency. Other circuitry may be located within the first and second execute stages 10, 12 as well as in the third execute stage 14 and subsequent pipeline stages not shown at FIG. 1.

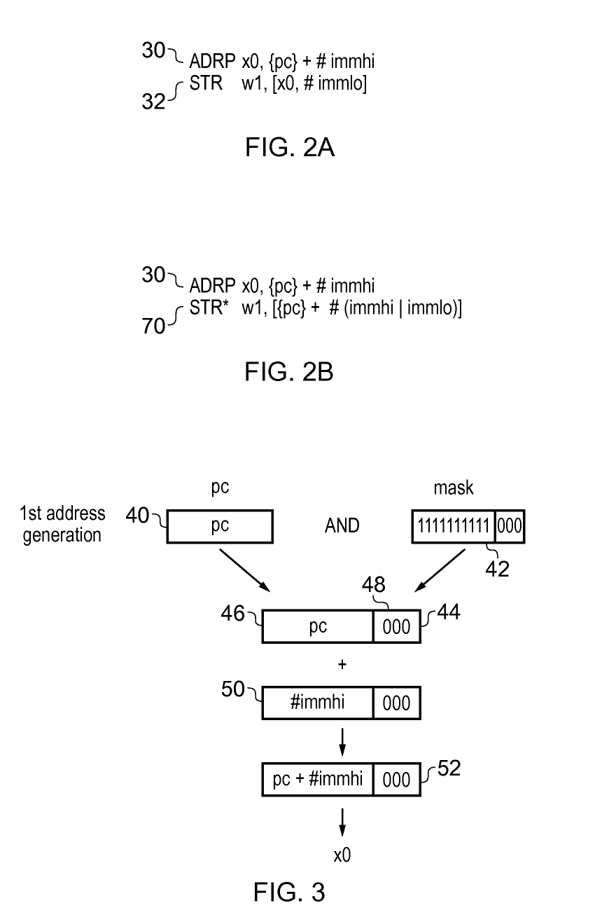

FIG. 2A shows an example of a sequence of instructions including a first instruction 30 and a second instruction 32. The first instruction 30 is an ADRP instruction for generating a first portion of an address. FIG. 3 shows a first address generation operation which is performed by the ALU 20 in the second execute stage 12 in response to the ADRP instruction 30. The ADRP instruction 30 specifies a destination register x0 and an immediate value #immhi. The ADRP instruction 30 also uses a program counter pc stored in a program counter register of the data processing apparatus 2. The program counter pc indicates an address of an instruction to be processed (e.g. the current instruction or a next instruction). The program counter is not explicitly identified in the encoding of the ADRP instruction 30. As shown in FIG. 3, in response to the ADRP instruction 30, the ALU 20 combines the program counter value 40 with a mask 42 using an AND operation to generate a masked program counter value 44 having an upper portion 46 which is the same as the corresponding portion of the program counter register and a lower portion 48 with bit values of 0. The mask 42 is predetermined so that the upper portion 46 of the program counter corresponds to the page address of the page of memory including the address of the instruction to be processed while the lower portion 48 corresponds to an offset within that page. The ALU 20 then adds the masked program counter value 44 to the immediate value #immhi which is aligned with the upper portion 46 of the program counter by performing a shift operation. The sum of the masked program counter value 44 and the shifted immediate value 50 is stored to register x0 and represents the page address 52 of another page of the memory address space. The first operand generation operation could in another embodiment be performed by the AGU 18 instead of the ALU 20 if desired.

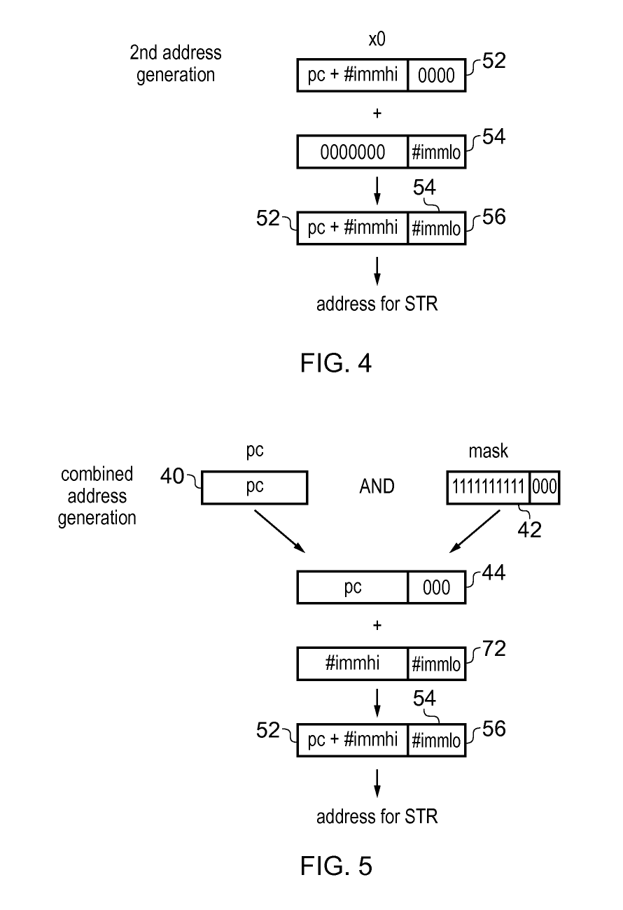

The second instruction 32 of FIG. 2A is a store instruction STR for storing a data value currently stored in a register to a location within memory. The store instruction 32 specifies a source register w1 storing the data value to be stored to memory, a second register x0 storing an operand, and an immediate value #immlo to be added to the operand stored in register x0 to obtain the full address of the data value. The register x0 is the same as the destination register x0 of the ADRP instruction 30, and so the store instruction 32 is dependent on the ADRP instruction 30. FIG. 4 shows the second address generation operation performed in response to the store instruction 32 by the AGU 18. Following execution of the ADRP 30 instruction the source register x0 contains the page address 52 generated by the first address generation operation. In response to the store instruction 32, the AGU 18 adds the immediate value #immlo 54 to the page address 52 to produce a full address 56 including both the page address 52 and a page offset 54 represented by the immediate value #immlo. The full address 56 is used for the subsequent store operation by data cache accessing circuitry 22.

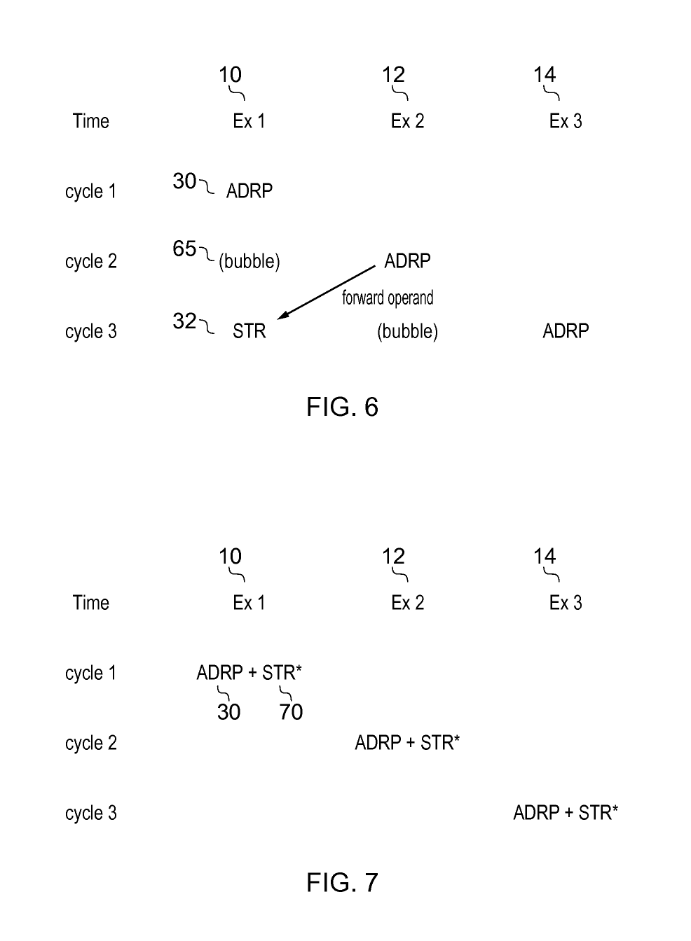

Since the second address generation operation of the store instruction 32 requires the outcome of the ADRP instruction 30, then processing these instructions places constraints on the timings at which they can be scheduled. The first address generation operation of FIG. 3 is performed at the ALU 20 and so the outcome of this will not be available until the ADRP instruction reaches the second execute stage 12. While there are potential forwarding paths 60 available in the pipeline of FIG. 1, it is unlikely that these can return the outcome of the first address generation to the AGU 18 until the following cycle and so the store instruction 32 cannot be processed by the AGU 18 until the cycle following the completion of the first address generation in the ALU 20. As shown in FIG. 6, this means that the store instruction 32 would need to be issued two cycles after the ADRP instruction 30 to give enough time for the result of the ADRP instruction to be forwarded to the first execute stage 10 for use when processing the store instruction. Therefore, a bubble 65 may occur in the pipeline (in processing cycle 2 there is no instruction being processed by the first execute stage). In an in-order processor, this bubble cannot be filled by issuing another instruction ahead of the store instruction 32. Therefore, fewer instructions can be processed in a given period of time, and so performance is reduced.

To address this problem, the decode stage 6 may check the received stream of instructions to detect sequences of the type shown in FIG. 2A in which a second instruction 32 for performing a second operand generation operation depends on the first instruction 30 for performing a first operand generation operation. The first and second instructions 30, 32 do not need to be consecutive and there may be one more intervening instructions between the first and second instructions 30, 32. When this type of sequence is detected, the decode stage 6 replaces it with a modified sequence of instructions as shown in FIG. 2B in which at least the second instruction is replaced with a modified store instruction STR* 70 (“third instruction”) which performs a combined address generation operation. The combined address generation operation is performed by the AGU 18 so that a store operation can be performed by data cache access circuitry 22 in the following cycle.

As shown in FIG. 5, the combined address generation operation performed in response to the third instruction combines the program counter 40 with the mask 42 and then adds the masked program counter value 44 to a combined immediate value 72 in which the upper and lower immediate values #immhi and #immlo are concatenated. The sum of the masked program counter value 44 and the combined immediate value 72 yields the fill address 56 including both the page address 52 and the page offset 54, which is the same as the result of the second address generation shown in FIG. 4. Hence, the combined address generation operation has the same result as would have occurred had the first and second address generation operations been performed in sequence. The modified store instruction 70 for performing the combined address generation no longer depends on the ADRP instruction 30, and so can be scheduled to be performed in the same cycle or in a consecutive cycle. As shown in FIG. 7, in a system in which it is possible to issue multiple instructions per cycle, the ADRP instruction 30 and the modified store instruction 70 can be issued in the same cycle to improve processing performance.

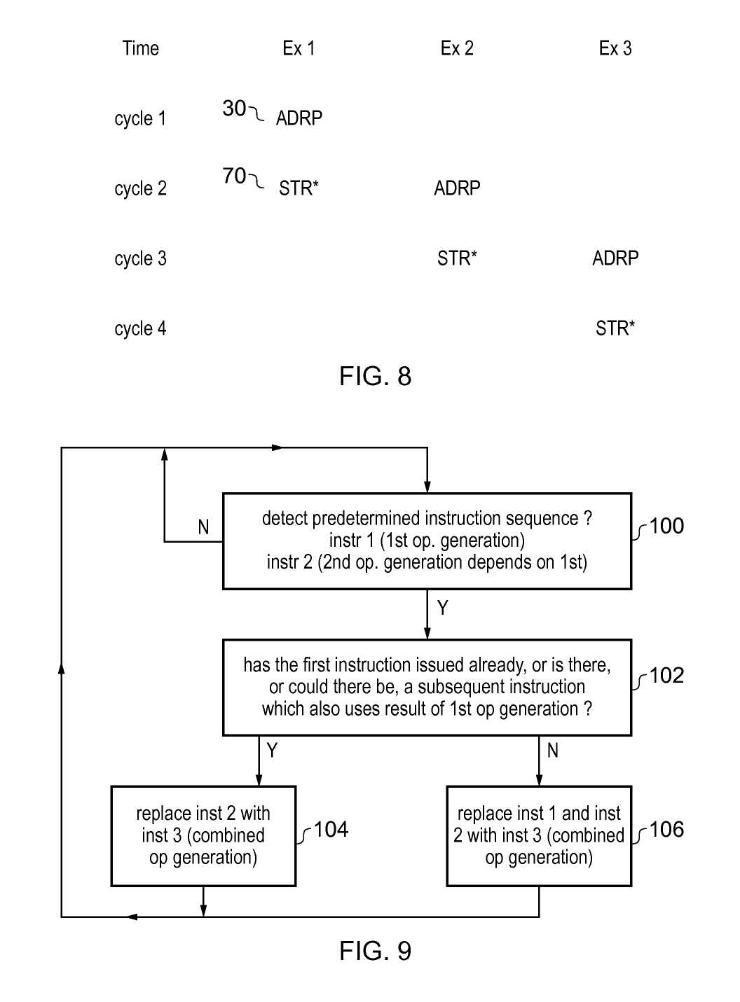

Alternatively, if the pipeline can only issue one instruction per cycle, then the ADRP and the modified store instructions 30, 70 can be issued in consecutive cycles as shown in FIG. 8, which will still allow the store instruction 70 to be processed a cycle earlier than in FIG. 6.

While the ADRP instruction 30 is no longer necessary for generating the correct result for the modified store instruction 70, there may be subsequent instructions which require the value placed in register x0 by the ADRP instruction 30 and so it may still be necessary to execute the ADRP instruction 30. If it is known that there cannot be any further instructions which use the value in x0, for example if a subsequent instruction overwrites the value in x0, then the ADRP instruction 30 could also be replaced with the modified store instruction 70.

The instruction 32 which uses the result of the address generating instruction 30 does not need to be store instruction and could also be a load instruction or an arithmetic or logical instruction performed by the ALU 20 using the value generated by the first instruction 30. The operands generated by these instructions may be any operand and not just an address. The combined operation may be performed in any stage of the pipeline, so it is not essential for this to be carried out using the AGU 18 in the first execute stage 10 as discussed above. Also, in some implementations the first execute stage 10 may be combined with the issue stage 8 in a single pipeline stage, so that instruction issuing, register reads and address generation in the AGU 18 can all be performed in the same processing cycle.

In the example discussed above, the decode stage 6 detects the predetermined sequence of instructions and replaces it with the modified stream of instructions, but this could also be performed at the issue stage 8. For example, the decode stage 6 or issue stage 8 may have a FIFO (first in first out) buffer with a certain number N of entries, and each instruction received by that stage 6, 8 may be written to the FIFO buffer, with the oldest instruction from the buffer being evicted to make way for the new instruction. In each processing cycle, the decode stage 6 or issue stage 8 may detect the predetermined sequence if the FIFO buffer includes both a first instruction 30 and a second instruction 32 which is dependent on the first instruction 30 and for which the first instruction 30 is not expected to yield its outcome in time for the second instruction 32 if these instructions were processed in their original form. The number of entries J in the FIFO buffer determines the maximum number (N=J−2) of intervening instructions that can occur between the first and second instructions detected as the predetermined sequence.

FIG. 9 shows a method of processing instructions in a pipeline. At step 100 a first pipeline stage (e.g. the decode or issue stage 6, 8) detects whether the stream of instructions to be processed includes a predetermined instruction sequence comprising a first instruction for performing first operand generation and a second instruction for performing second operand generation which is dependent on the first operand generation. If the operand generation uses a portion of the program counter, then step 100 may also check whether the first and second instructions have the same value for a relevant portion of the program counter, and otherwise may not detect the predetermined instruction sequence. If the predetermined instruction sequence is not detected then no instruction replacement is made and the original instructions are processed by the pipeline. The method then returns to step 100 for a subsequent processing cycle.

If the predetermined sequence of instructions is detected, then at step 102 it is determined whether the first instruction has been issued already, or there is, or could be, a subsequent instruction other than the second instruction which uses the result of the first instruction. If the first instruction has already been issued, then it is more efficient to allow the instruction to complete, even if its outcome is not required by any other instruction. Therefore, at step 104 only the second instruction is replaced with a modified third instruction providing the combined operand generation operation equivalent to performing the first and second operand generation operations in sequence. Also, if there is, or could be, a subsequent instruction other than the second instruction which is dependent on the outcome of the first instruction, then the first instruction should remain in the modified stream and so again at step 104 only the second instruction is replaced with the third instruction. On the other hand, if the first instruction has not yet issued, and there cannot be a subsequent instruction which uses the result of the first operand generation, then at step 106 both the first and second instructions are replaced with a combined instruction. Where it is possible to replace both the first and second instructions, then this is useful because eliminating the first instruction frees a slot in the pipeline which can be used for processing another instruction. However, in practice, the hardware for detecting whether this is possible may be complex and it may be more efficient to always choose step 104 so that only the second instruction is replaced by the third instruction and the first instruction remains in the modified instruction stream. The method then returns to step 100 for the following processing cycle.

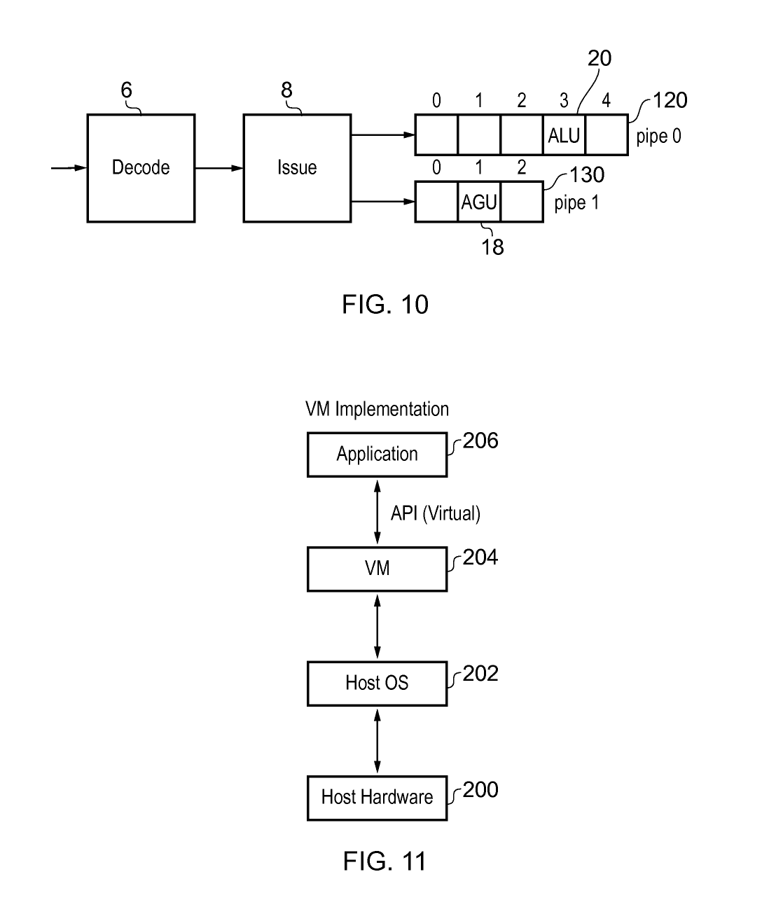

While FIG. 1 shows a single processing pipeline having multiple processing paths through it, as shown in FIG. 10 it is also possible for multiple execution pipelines 120, 130 to be provided. A common decode stage 6 and common issue stage 8 are provided which are shared by both pipelines 120, 130. The issue stage 8 determines which pipeline 120, 130 to issue instructions to, depending on the functionality available in each pipeline, the type of instruction, and/or the current processing workload of each pipeline 120, 130. As shown in FIG. 10, the pipeline stages including the ALU 20 and AGU 18 may be within different pipelines 120, 130, but data dependency issues may still occur between the instructions processed by these stages. Therefore, replacing the second instruction 32 with a third instruction 70 also provides a performance improvement in this embodiment.

FIG. 11 illustrates a virtual machine implementation that may be used. While the earlier described embodiments implement the present invention in terms of apparatus and methods for operating specific processing hardware supporting the techniques concerned, it is also possible to provide so-called virtual machine implementations of hardware devices. These virtual machine implementations run on a host processor 200 typically running a host operating system 202 supporting a virtual machine program 204. Typically, large powerful processors are required to provide virtual machine implementations which execute at a reasonable speed, but such an approach may be justified in certain circumstances, such as when there is a desire to run code native to another processor for compatibility or re-use reasons. The virtual machine program 204 is capable of executing an application program (or operating system) 206 to give the same results as would be given by execution of the program by a real hardware device. Thus, the program instructions described above may be executed from within the application program 206 using the virtual machine program 204 to replicate the processing of the real pipeline(s) 4 or 120, 130.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

We claim:

1. A processor comprising:
at least one processing pipeline configured to process a stream of instructions, the at least one processing pipeline comprising a first pipeline stage, a second pipeline stage and a third pipeline stage; wherein:
the first pipeline stage is configured to detect whether the stream of instructions comprises a predetermined instruction sequence comprising a first instruction for performing a first operand generation operation at the third pipeline stage and a second instruction for performing a second operand generation operation at the second pipeline stage, where the second operand generation operation is dependent on an outcome of the first operand generation operation; and
in response to detecting that the stream of instructions comprises said predetermined instruction sequence, the first pipeline stage is configured to generate a modified stream of instructions for processing by the at least one processing pipeline in which at least the second instruction is replaced with a third instruction for performing a combined operand generation operation for generating an operand equivalent to the operand which would be generated if the second operand generation operation was performed after the first operand generation operation.

2. The processor according to claim 1, wherein an instruction at the first pipeline stage requires X processing cycles to reach the second pipeline stage and Y processing cycles to reach the third pipeline stage, where Y and X are integers and Y≧X.

3. The processor according to claim 1, wherein the combined operand generation operation is independent of the outcome of the first operand generation operation.

4. The processor according to claim 1, wherein the operand comprises an address.

5. The processor according to claim 1, wherein the first operand generation operation is for generating a first portion of the operand, the second operand generation operation is for generating the operand including the first portion and a second portion, and the combined operand generation operation is for generating the operand including the first portion and the second portion.

6. The processor according to claim 5, wherein the operand comprises a greater number of bits than can be encoded in an instruction encoding of a single instruction of said stream of instructions.

7. The processor according to claim 5, wherein the first operand generation operation comprises generating the first portion of the operand by adding an offset value to at least a portion of a base value stored in a storage location.

8. The processor according to claim 7, wherein the operand comprises an address and the base value comprises a program counter indicating an address of an instruction to be processed.

9. The processor according to claim 8, wherein the first pipeline stage is configured to detect, as the predetermined instruction sequence, a sequence of instructions in which the first instruction and the second instruction have the same value for said at least a portion of said program counter.

10. The processor according to claim 8, wherein the at least a portion of the base value comprises a most significant portion of the base value.

11. The processor according to claim 10, wherein the first operand generation operation comprises masking a least significant portion of the base value.

12. The processor according to claim 10, wherein the second operand generation operation comprises adding an immediate value to a least significant portion of the result of the first operand generation operation.

13. The processor according to claim 1, wherein the second instruction is for performing a processing operation using the operand generated by the second operand generation operation, and
the third instruction is for performing said processing operation using the operand generated by the combined operand generation operation.

14. The processor according to claim 13, wherein the processing operation comprises at least one of:
a load operation;
a store operation;
an arithmetic operation; and
a logical operation.

15. The processor according to claim 1, wherein the modified stream of instructions comprises the first instruction and the third instruction.

16. The processor according to claim 15, wherein the at least one processing pipeline is configured to schedule processing of the third instruction independently of processing of the first instruction.

17. The processor according to claim 1, wherein the modified stream of instructions comprises the third instruction and does not comprise the first instruction.

18. The processor according to claim 1, wherein the first pipeline stage is configured to determine whether the stream of instructions comprises a fourth instruction which is dependent on the outcome of the first operand generation operation of the first instruction;
if the stream of instructions comprises the fourth instruction, then the first processing stage is configured to replace the second instruction with the third instruction to generate the modified stream of instructions comprising the first instruction, the third instruction and the fourth instruction; and
if the stream of instructions does not comprise the fourth instruction, then the first processing stage is configured to replace the first instruction and the second instruction with the third instruction to generate the modified stream of instructions comprising the third instruction and not comprising the first instruction.

19. The processor according to claim 1, wherein the first pipeline stage is configured to determine whether a subsequent instruction of the stream of instructions could be dependent on the outcome of the first operand generation operation of the first instruction;
if a subsequent instruction could be dependent on the outcome of the first operand generation operation, then the first processing stage is configured to replace the second instruction with the third instruction to generate the modified stream of instructions comprising the first instruction and the third instruction; and
if no subsequent instruction could be dependent on the outcome of the first operand generation operation, then the first processing stage is configured to replace the first instruction and the second instruction with the third instruction to generate the modified stream of instructions comprising the third instruction and not comprising the first instruction.

20. The processor according to claim 1, wherein the first pipeline stage is configured to detect, as the predetermined instruction sequence, a sequence of instructions comprising a maximum of N intervening instructions between the first instruction and the second instruction, where N is an integer and N≧0.

21. The processor according to claim 20, wherein N>0.

22. The processor according to claim 1, wherein the first pipeline stage comprises a decode stage configured to decode instructions to be processed by the at least one processing pipeline, and the modified stream of instructions comprises a stream of decoded instructions.

23. The processor according to claim 1, wherein the first pipeline stage comprises an issue stage configured to issue instructions for processing by the at least one processing pipeline.

24. The processor according to claim 1, wherein the second pipeline stage and the third pipeline stage are respective stages of the same processing pipeline.

25. The processor according to claim 1, wherein the second pipeline stage and the third pipeline stage are the same pipeline stage.

26. The processor according to claim 1, wherein the second pipeline stage and the third pipeline stage are stages of different processing pipelines.

27. The processor according to claim 1, wherein the processor is an in-order processor.

28. The processor according to claim 27, wherein the stream of instructions has a predetermined program order; and
the at least one processing pipeline comprises an issue stage configured to issue instructions for processing in the same order as the predetermined program order.

29. A processor comprising:
at least one processing pipeline means for processing a stream of instructions, the at least one processing pipeline means comprising first, second and third pipeline stage means for processing instructions; wherein:
the first pipeline stage means is configured to detect whether the stream of instructions comprises a predetermined instruction sequence comprising a first instruction for performing a first operand generation operation at the third pipeline stage means and a second instruction for performing a second operand generation operation at the second pipeline stage means, where the second operand generation operation is dependent on an outcome of the first operand generation operation; and
in response to detecting that the stream of instructions comprises said predetermined instruction sequence, the first pipeline stage means is configured to generate a modified stream of instructions for processing by the at least one processing pipeline means in which at least the second instruction is replaced with a third instruction for performing a combined operand generation operation for generating an operand equivalent to the operand which would be generated if the second operand generation operation was performed after the first operand generation operation.

30. A data processing method for a processor comprising at least one processing pipeline configured to process a stream of instructions, the at least one processing pipeline comprising a first pipeline stage, a second pipeline stage and a third pipeline stage; the method comprising:
detecting, at the first pipeline stage, whether the stream of instructions comprises a predetermined instruction sequence comprising a first instruction for performing a first operand generation operation at the third pipeline stage and a second instruction for performing a second operand generation operation at the second pipeline stage, where the second operand generation operation is dependent on an outcome of the first operand generation operation; and
in response to detecting that the stream of instructions comprises said predetermined instruction sequence, the first pipeline stage generating a modified stream of instructions for processing by the at least one processing pipeline in which at least the second instruction is replaced with a third instruction for performing a combined operand generation operation for generating an operand equivalent to the operand which would be generated if the second operand generation operation was performed after the first operand generation operation.

31. A computer-readable storage medium storing at least one computer program which, when executed on a computer controls the computer to provide a virtual machine environment corresponding to the processor of claim 1.

32. A computer-readable storage medium storing at least one computer program which, when executed on a computer controls the computer to provide a virtual machine environment for performing the method of claim 30.
